(19) United States
(12) Patent Application Publication
(10) Pub. No.: US 2019/0311589 A1
(43) Pub. Date: Oct. 10, 2019

(54) APPARATUS AND METHOD FOR PROVIDING VIRTUAL TEXTURE

(71) Applicant: POSTECH ACADEMY-INDUSTRY FOUNDATION, Pohang-si (KR)

(72) Inventors: Seung Moon CHOI, Pohang-si (KR); Sung Hwan SHIN, Jeju-si (KR)

(21) Appl. No.: 16/191,378

(22) Filed: Nov. 14, 2018

(30) Foreign Application Priority Data
Apr. 5, 2018 (KR) 10-2018-0040014

(51) Int. Cl. G08B 6/00; G06F 3/01; G06N 3/08

(52) U.S. Cl. CPC G08B 6/00; G06N 3/08; G06F 3/016

(57) ABSTRACT

Disclosed are an apparatus and method for providing a virtual texture. The apparatus and method for providing a virtual texture includes a signal generator, a signal adjuster, and a signal output part to generate composite tactile signal including a virtual vibrotactile signal and a virtual force-feedback signal so that a virtual texture of a target object may be reproduced in a virtual reality.

### CROSS-REFERENCE TO RELATED APPLICATION

This application claims priority to Korean Patent Application No. 2018-0040041 filed on Apr. 5, 2018 in the Korean Intellectual Property Office (KIPO), the entire contents of which are hereby incorporated by reference.

### BACKGROUND

### 1. Technical Field

Example embodiments of the present invention relate to an apparatus for providing a virtual texture, and more particularly, to an apparatus and method for providing a virtual texture, which provide haptic effects.

### 2. Related Art

With development of computer and information technologies, the number of apparatuses configured to provide sensory information in virtual realities increases. However, most apparatuses for providing sensations provide visual information or auditory information, and apparatuses for providing tactile information are relatively limited to mobile devices such as mobile phones and tablets configured to providing alarm functions through vibrations.

A haptic technology which provides tactile information to a user when a fingertip (an end of a figure or a stylus pen) comes into contact with an object generally includes vibrotactile information and force-feedback information. Here, the vibrotactile information may be stimulation signal information felt when skin comes into contact with a surface of an object, and a force-feedback signal may be sensation signal information felt when movement of a joint or muscle is disturbed. Recently, studies for using the vibrotactile information and the force-feedback information to reproduce a virtual texture of the object in a virtual reality have been actively carried out.

An apparatus for providing a virtual texture, which reproduces a virtual texture of an object, includes an apparatus for providing a virtual texture, which reproduces a force-feedback signal, and an apparatus for providing a virtual texture, which reproduces a vibrotactile signal.

The conventional apparatus for providing a virtual texture, which reproduces the force-feedback signal, is suitable to express an object having a rough surface. However, the apparatus for providing a virtual texture, which reproduces the force-feedback signal, has a disadvantage in that touch sensation information of a material felt when coming into contact with an object is not provided.

In addition, the apparatus for providing a virtual texture, which provides the vibrotactile signal, transmits touch sensation information of a material when a user comes into contact with an object but has a disadvantage in that information about a surface roughness of an object or information about a height of the object is not provided.

### SUMMARY

Accordingly, example embodiments of the present invention are provided to substantially obviate one or more problems due to limitations and disadvantages of the related art.

Example embodiments of the present invention provide an apparatus for providing a virtual texture, which has high precision and high performance.

Example embodiments of the present invention also provide a method of providing a virtual texture, which has high precision and high performance.

In some example embodiments, an apparatus for providing a virtual texture includes a signal generator configured to come into contact with a target object to generate a virtual vibrotactile signal and a virtual force-feedback signal reproduced from a touch sensation signal of the target object, a signal adjuster configured to adjust signal characteristics of the virtual vibrotactile signal and the virtual force-feedback signal, and a signal output part configured to output the virtual vibrotactile signal and the virtual force-feedback signal of which the signal characteristics are adjusted to provide a virtual composite tactile signal to a user.

Here, the signal generator may include a first generator configured to obtain the virtual vibrotactile signal through a simulation of a vibration model.

Here, the vibration model may be made by obtaining vibration acceleration data generated when the user comes into contact with a surface of the target object and modeling a changing pattern of the obtained acceleration data by using machine learning of a neural network.

In addition, the signal generator may include a second generator configured to obtain the virtual force-feedback signal through a simulation of a geometric model.

The geometric model may be made by obtaining geometric data of the target object using at least one sensor and modeling the obtained geometric data.

The signal adjuster may include a first adjuster configured to adjust a size of the vibrotactile signal to have a predetermined ratio with a size of the virtual force-feedback signal.

In addition, the signal adjuster may include a second adjuster configured to adjust frequency components of the virtual vibrotactile signal and the virtual force-feedback signal.

Here, the second adjuster may perform short-time Fourier transforms on the virtual vibrotactile signal and the virtual force-feedback signal, combine the transformed virtual vibrotactile signal and the transformed virtual force-feedback signal, filter the combined signal through at least one filter, and perform an inverse short-time Fourier transform on filtered signals to adjust the frequency components of the virtual vibrotactile signal and the virtual force-feedback signal.

Here, the filter may include a first filter serving as a high pass filter and a second filter serving as a low pass filter.

Here, the first filter may filter the virtual vibrotactile signal having a high frequency component from the combined signal.

In addition, the second filter may filter the virtual force-feedback signal having a low frequency component in the combined signal.

The signal output part may include a first output part configured to output the virtual vibrotactile signal of which a signal characteristic is adjusted, and a second output part configured to output the virtual force-feedback signal of which a signal characteristic is adjusted.

In other example embodiments, a method of providing a virtual texture includes a signal generation operation of generating a virtual vibrotactile signal and a virtual force-feedback signal which are reproduced from a touch sensation signal of a target object, a signal adjustment operation of adjusting signal characteristics of the virtual vibrotactile signal and the virtual force-feedback signal, and a signal output operation of outputting the adjusted virtual vibrotactile signal and the adjusted virtual force-feedback signal to provide virtual tactile information to a user.

Here, the signal generation operation may include generating the virtual vibrotactile signal through a simulation of a vibration model of the target object and generating the virtual force-feedback signal through a simulation of a geometric model of the target object.

Here, the vibration model may be made by obtaining vibration acceleration data generated when the user comes into contact with a surface of the target object and modeling a changing pattern of the obtained acceleration data by using machine learning of a neural network.

In addition, the geometric model may be made by obtaining geometric data of the target object using at least one sensor of an image sensor and a touch sensor and modeling the obtained geometric data.

The signal adjustment operation may include a first adjustment operation of adjusting a size of the vibrotactile signal to have a predetermined ratio with a size of the virtual force-feedback signal.

In addition, the signal adjustment operation may include a second adjustment operation of adjusting frequency components of the virtual vibrotactile signal and the virtual force-feedback signal.

Here, the second adjustment operation may include performing short-time Fourier transforms on the virtual vibrotactile signal and the virtual force-feedback signal, combining the transformed virtual vibrotactile signal and the transformed virtual force-feedback signal to generate a combined signal, filtering the combined signal, and performing inverse short-time Fourier transforms on filtered signals.

In addition, the filtering of the combined signal may include obtaining the virtual vibrotactile signal having a high frequency component from the combined signal using a high pass filter and obtaining the virtual force-feedback signal having a low frequency component from the combined signal using a low pass filter.

### BRIEF DESCRIPTION OF DRAWINGS

Example embodiments of the present invention will become more apparent by describing example embodiments of the present invention in detail with reference to the accompanying drawings, in which:

FIG. 1 is a block diagram illustrating an apparatus for providing a virtual texture according to an embodiment of the present invention;

FIG. 2 is a block diagram illustrating a signal adjuster in the apparatus for providing a virtual texture according to the embodiment of the present invention;

FIG. 3 is a flowchart of a method of providing a virtual texture according to the embodiment of the present invention; and

FIG. 4 is a flowchart for describing a signal adjustment operation of the method of providing a virtual texture according to the embodiment of the present invention.

### DESCRIPTION OF EXAMPLE EMBODIMENTS

As the invention allows for various changes and numerous embodiments, specific embodiments will be illustrated in the drawings and described in detail in the written description. However, this is not intended to limit the present invention to specific modes of practice, and it is to be appreciated that all changes, equivalents, and substitutes that do not depart from the spirit and technical scope of the present invention are encompassed in the present invention. Like numbers refer to like elements throughout the description of the drawings.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element without departing from the scope of the present invention. As used herein, the term “and/or” includes any one or a combination of the associated listed items.

It will be understood that when an element is referred to as being “connected” or “coupled” to another element, it can be directly connected or coupled thereto or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings. In order to facilitate overall understanding of the invention, like reference numerals in the drawings denote like elements, and thus the description thereof will not be repeated.

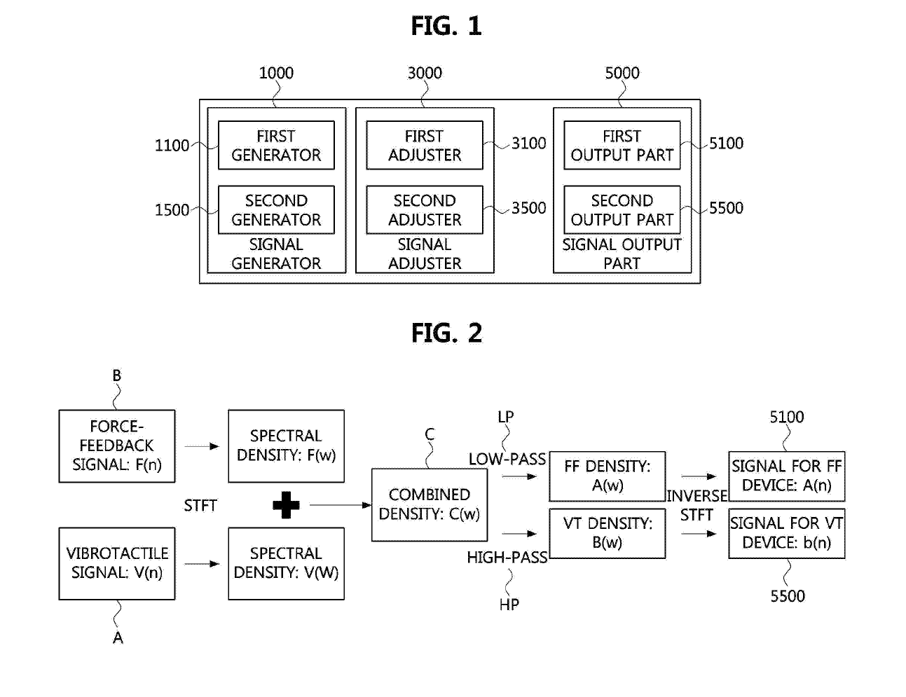

FIG. 1 is a block diagram illustrating an apparatus for providing a virtual texture according to an embodiment of the present invention.

Referring to FIG. 1, the apparatus for providing a virtual texture may provide an actual texture of a target object as a virtual composite signal. According to the embodiment, the virtual composite signal may include a vibrotactile signal and a force-feedback signal.

More specifically, the apparatus for providing a virtual texture may include a signal generator 1000, a signal adjuster 3000, and a signal output part 5000.

The signal generator 1000 may generate a virtual signal which is reproduced from a touch sensation signal obtained from a target object.

The signal generator 1000 may include a first generator 1100 and a second generator 1500.

The first generator 1100 may generate a virtual vibrotactile signal of the target object. More specifically, the first generator 1100 may obtain acceleration data from a vibrotactile signal generated from a surface of the target object to generate the virtual vibrotactile signal when a user comes into contact with the actual target object.

According to the embodiment, the first generator 1100 may obtain the virtual vibrotactile signal through a simulation of a vibration model. Here, when the user comes into contact with the target object, the vibration acceleration data generated from the surface of the target object may be obtained. Next, a changing pattern of the obtained acceleration data may be modeled to from the first generator 1100. For example, the vibration model may be a learning model using machine learning of a neural network.

The second generator 1500 may generate a virtual force-feedback signal of the target object. More specifically, according to the embodiment, the second generator 1500 may obtain geometric data of the target object using at least one sensor. For example, the sensor may be a touch sensor or image sensor.

Next, the second generator 1500 may generate a geometric model on the basis of the obtained geometric data. Accordingly, the second generator 1500 may generate the virtual force-feedback signal of the target object using the generated geometric model.

Here, the virtual force-feedback signal may be a virtual signal which is reproduced from a passive or active sensation felt by a user when interacting with the target object.

According to one embodiment, in a case in which a change in a geometry of the target object is large, the second generator 1500 may provide the virtual force-feedback signal of which a size and a direction are continuously changed to provide a rough virtual texture to the user.

According to another embodiment, in a case in which the change in the geometry of the target object is small, the second generator 1500 may provide the virtual force-feedback signal in which changes in the size and the direction are small to provide a smooth virtual texture to the user.

The first generator 1100 and the second generator 1500 are not limited thereto and may externally receive the acceleration data and geometric data obtained from the actual target object to generate the virtual vibrotactile signal and the virtual force-feedback signal.

FIG. 2 is a block diagram illustrating a signal adjuster in the apparatus for providing a virtual texture according to the embodiment of the present invention.

Referring to FIG. 2, the signal adjuster 3000 may adjust signal characteristics of the virtual vibrotactile signal and the virtual force-feedback signal.

More specifically, the signal adjuster 3000 may include a first adjuster 3100 and a second adjuster 3500.

The first adjuster 3100 may adjust the size of the virtual vibrotactile signal received from the signal generator 1000.

More specifically, according to the embodiment, as described above, a size of the virtual force-feedback signal may continuously change. Accordingly, in a case in which the size of the virtual force-feedback signal is less than or greater than that of the virtual vibrotactile signal, it is difficult for the signal output part 5000, which will be described below, to output a balanced composite tactile signal. Accordingly, the first adjuster 3100 may adjust the size of the virtual vibrotactile signal to be proportional to the size of the virtual force-feedback signal.

The apparatus for providing a virtual texture according to the embodiment of the present invention may provide the virtual force-feedback signal and the virtual vibrotactile signal in a state in which a predetermined ratio between the size of virtual force-feedback signal and the size of the virtual vibration is maintained by the first adjuster 3100 so that the apparatus for providing a virtual texture, which provides a high precision composite tactile signal, can be provided to the user.

Next, the first adjuster 3100 may transmit the virtual vibrotactile signal and the virtual force-feedback signal, of which sizes are adjusted, to the second adjuster 3500 which will be described below.

The second adjuster 3500 may adjust frequency components of the virtual vibrotactile signal and the virtual force-feedback signal received from the first adjuster 3100. Accordingly, when the signal output part 5000, which will be described below, outputs a virtual vibrotactile signal A and a virtual force-feedback signal B, the second adjuster 3500 may prevent interference between the signals.

More specifically, according to the embodiment, the second adjuster 3500 may perform short-time Fourier transforms (STFTs) on the virtual vibrotactile signal A and the virtual force-feedback signal B of which sizes are adjusted. In other words, the second adjuster 3500 may calculate a spectral density of each of the virtual vibrotactile signal A and the virtual force-feedback signal B of which sizes are adjusted.

The second adjuster 3500 may combine the spectral densities generated by performing the STFT on each of the virtual vibrotactile signal A and the virtual force-feedback signal B. Next, the second adjuster 3500 may filter the combined spectral density C.

According to one embodiment, the second adjuster 3500 may separate a spectral density of the virtual vibrotactile signal A using a high pass filter HP. More specifically, the second adjuster 3500 may pass the combined spectral density through the high pass filter HP to obtain the spectral density of the virtual vibrotactile signal A having only a high frequency component.

According to another embodiment, the second adjuster 3500 may separate a spectral density of the virtual force-feedback signal B using a low pass filter LP. More specifically, the second adjuster 3500 may pass the combined spectral density through the low pass filter LP to obtain the spectral density of the virtual force-feedback signal B having only a low frequency component.

Next, the second adjuster 3500 may perform an inverse STFT on the spectral density of each of the obtained virtual vibrotactile signal A and the virtual force-feedback signal B. Accordingly, the second adjuster 3500 may generate the virtual vibrotactile signal A having only the high frequency component and the virtual force-feedback signal B having only the low frequency component.

Since the apparatus for providing a virtual texture according to the embodiment of the present invention provides the virtual vibrotactile signal and the virtual force-feedback signal which have different frequency components, a beating phenomenon generated when signals are combined is prevented so that the apparatus for providing a virtual texture, which has high performance with no loss, can be provided.

Referring again to FIG. 1, the signal output part 5000 may output the virtual vibrotactile signal and the virtual force-feedback signal filtered by the signal adjuster 3000.

More specifically, the signal output part 5000 may include a first output part 5100 and a second output part 5500.

The first output part 5100 may output the virtual vibrotactile signal adjusted by the signal adjuster 3000.

In addition, the second output part 5500 may output the virtual force-feedback signal adjusted by the signal adjuster 3000.

The first output part 5100 and the second output part 5500 may simultaneously output the signals to provide a composite tactile signal to the user. According to the embodiment, the first output part 5100 and the second output part 5500 may be actuators.

The apparatus for providing a virtual texture according to the embodiment of the present invention may reproduce the virtual composite tactile signal from the vibrotactile signal and the force-feedback signal, which express a virtual texture of the actual target object to provide the virtual texture of the actual target object in a virtual reality to the user.

As described above, the apparatus for providing a virtual texture according to the embodiment of the present invention has been described. Hereinafter, a method of providing a virtual texture using the apparatus for providing a virtual texture according to the embodiment of the present invention will be described below.

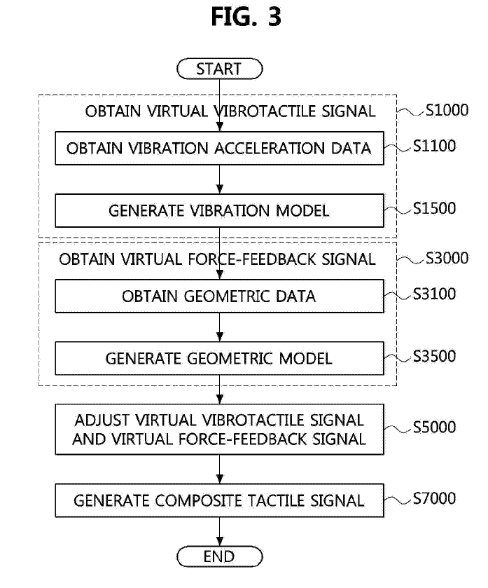

FIG. 3 is a flowchart of the method of providing a virtual texture according to the embodiment of the present invention.

Referring to FIG. 3, the apparatus for providing a virtual texture may obtain a virtual vibrotactile signal from a target object (S1000).

More specifically, according to the embodiment, the apparatus for providing a virtual texture may obtain vibration acceleration data of the target object (S1100). Here, the apparatus for providing a virtual texture may come into contact with the target object to obtain the acceleration data or may operate in conjunction with a separate external apparatus to obtain the acceleration data of the target object.

The apparatus for providing a virtual texture may generate a vibration model on the basis of a changing pattern of the obtained acceleration data (S1500). Next, a virtual vibrotactile signal may be generated using the generated vibration model.

The apparatus for providing a virtual texture may obtain a virtual force-feedback signal from the target object (S3000). More specifically, according to the embodiment, the apparatus for providing a virtual texture may obtain geometric data from the target object (S3100). Here, the apparatus for providing a virtual texture may measure the geometric data using at least one sensor or operate in conjunction with an external apparatus to obtain the geometric data of the target object.

The apparatus for providing a virtual texture may generate a geometric model on the basis of the obtained geometric data (S3500). Next, the apparatus for providing a virtual texture may generate the virtual force-feedback signal through a simulation using the obtained geometric model.

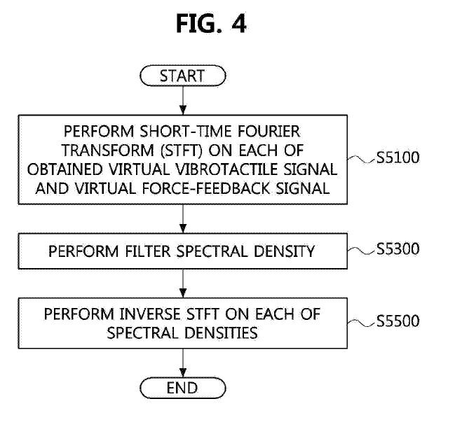

The apparatus for providing a virtual texture may adjust the generated virtual vibrotactile signal and the generated virtual force-feedback signal (S5000). A method of adjusting the signals will be more specifically described with reference to FIG. 4.

FIG. 4 is a flowchart for describing a signal adjustment operation of the method of providing a virtual texture according to the embodiment of the present invention.

Referring to FIG. 4, the apparatus for providing a virtual texture may perform a STFT on each of the obtained virtual vibrotactile signal and the obtained virtual force-feedback signal (S5100). Accordingly, the apparatus for providing a virtual texture may calculate spectral densities of the virtual vibrotactile signal and the virtual force-feedback signal.

Next, the apparatus for providing a virtual texture may combine the spectral densities calculated from the virtual vibrotactile signal and the virtual force-feedback signal. Next, the combined spectral density may be filtered (S5300).

According to one embodiment, the apparatus for providing a virtual texture may separate a spectral density of the virtual vibrotactile signal using the high pass filter. Accordingly, the apparatus for providing a virtual texture may obtain the spectral density of the virtual vibrotactile signal having only a high frequency component.

According to another embodiment, the apparatus for providing a virtual texture may separate a spectral density of the virtual force-feedback signal using the low pass filter. More specifically, the apparatus for providing a virtual texture may obtain the spectral density of the virtual force-feedback signal having only a low frequency component.

Next, the apparatus for providing a virtual texture may perform an inverse STFT on each of the spectral densities of the obtained virtual vibrotactile signal and the obtained virtual force-feedback signal (S5500). Accordingly, the apparatus for providing a virtual texture may generate the virtual vibrotactile signal having only the low frequency component and the virtual force-feedback signal having only the high frequency component.

Referring again to FIG. 3, the apparatus for providing a virtual texture may generate a composite tactile signal on the basis of the generated virtual vibrotactile signal and the generated virtual force-feedback signal (S7000). According to the embodiment, the apparatus for providing a virtual texture may simultaneously operate the first output part 5100 configured to output the virtual vibrotactile signal and the second output part 5500 configured to output the virtual force-feedback signal to generate the composite tactile signal.

The apparatus and method for providing a virtual texture according to the embodiment of the present invention have been described above.

The apparatus and method for providing a virtual texture may include the signal generator, the signal adjuster, and the signal output part to generate the composite tactile signal including the virtual vibrotactile signal and the virtual force-feedback signal so that the virtual texture of the target object can be reproduced in the virtual reality.

In addition, the apparatus for providing a virtual texture may be applied in various fields such as the medical training field and the home shopping field which provide a remote control environment.

The operation of the method according to the embodiment of the present invention may be implemented using programs or codes, which may be read by a computer, in recording media capable of being read by the computer. The recording media capable of being read by the computer includes any kind of recording device in which data is capable of being read by a computer system. In addition, the recording media capable of being read by the computer may be distributed within the computer system connected through a network so that the programs and codes capable of being read the computer may be stored and executed in a distributed manner.

In addition, the recording media which is capable of being read by the computer may include hardware devices such as a read-only memory (ROM), a random-access memory (RAM), and a flash memory, which are particularly configured to store and execute program commands. The program commands may include high language codes executed by the computer using an interpreter and the like, as well as machine codes generated by a compiler.

Some aspects of the present invention have been described in a context of an apparatus but may be described in a context of a corresponding method. Here, a block or apparatus corresponds to operations of the method or characteristics of the operations of the method. Similarly, aspects described in the context of the method may be described as a corresponding block or item, or a feature of a corresponding apparatus. Some or all operations of the method may be performed by (or using) a hardware device such as a microprocessor, a computer capable of programing, or an electronic circuit. In some embodiments, at least one operation among the most important operations of the method may be performed by such an apparatus.

In the embodiments, a logic device (for example, a field programmable gate array) capable of being programed may be used in order to perform some or all functions of the methods described in this specification. In the embodiments, the field programmable gate array may operate in conjunction with a microprocessor for performing one of the methods described in this specification. Generally, it is preferable that the methods be performed by a hardware device.

Since an apparatus and method for providing a virtual texture according to the embodiment of the present invention includes a signal generator, the apparatus and method for providing a virtual texture, which have high performance and generate a virtual vibrotactile signal and a virtual force-feedback signal through simple simulations of a vibration model and a geometric model, can be provided.

In addition, since the apparatus and method for providing a virtual texture includes a signal adjuster, the apparatus and method for providing a virtual texture, which adjust a size of the virtual vibrotactile signal to be proportional to a size of the virtual force-feedback signal to provide a high precision composite tactile signal, can be provided.

In addition, since the apparatus and method for providing a virtual texture includes a signal adjuster, the high efficiency apparatus and method for providing a virtual texture, which divide frequency components of the virtual vibrotactile signal and the virtual force-feedback signal to prevent interference between the vibrotactile signal and the virtual force-feedback signal, can be provided.

While the example embodiments of the present invention and their advantages have been described in detail, it should be understood that various changes, substitutions and alterations may be made herein without departing from the scope of the invention.

What is claimed is:

1. An apparatus for providing a virtual texture, comprising:
a signal generator configured to come into contact with a target object to generate a virtual vibrotactile signal and a virtual force-feedback signal reproduced from a touch sensation signal of the target object;
a signal adjuster configured to adjust signal characteristics of the virtual vibrotactile signal and the virtual force-feedback signal; and
a signal output part configured to output the virtual vibrotactile signal and the virtual force-feedback signal of which the signal characteristics are adjusted to provide a virtual composite tactile signal to a user.

2. The apparatus of claim 1, wherein the signal generator includes a first generator configured to obtain the virtual vibrotactile signal through a simulation of a vibration model.

3. The apparatus of claim 2, wherein the vibration model is made by obtaining vibration acceleration data generated when the user comes into contact with a surface of the target object and modeling a changing pattern of the obtained vibration acceleration data by using machine learning of a neural network.

4. The apparatus of claim 1, wherein the signal generator includes a second generator configured to obtain the virtual force-feedback signal through a simulation of a geometric model.

5. The apparatus of claim 4, wherein the geometric model is made by obtaining geometric data of the target object using at least one sensor and modeling the obtained geometric data.

6. The apparatus of claim 1, wherein the signal adjuster includes a first adjuster configured to adjust a size of the vibrotactile signal to have a predetermined ratio with a size of the virtual force-feedback signal.

7. The apparatus of claim 6, wherein the signal adjuster includes a second adjuster configured to adjust frequency components of the virtual vibrotactile signal and the virtual force-feedback signal.

8. The apparatus of claim 7, wherein the second adjuster is configured to:
perform short-time Fourier transforms on the virtual vibrotactile signal and the virtual force-feedback signal;
combine the transformed virtual vibrotactile signal and the transformed virtual force-feedback signal;
filter the combined signal through at least one filter; and
perform an inverse short-time Fourier transform on filtered signals to adjust the frequency components of the virtual vibrotactile signal and the virtual force-feedback signal.

9. The apparatus of claim 8, wherein the filter incudes a first filter serving as a high pass filter and a second filter serving as a low pass filter.

10. The apparatus of claim 9, wherein the first filter filters the virtual vibrotactile signal having a high frequency component from the combined signal.

11. The apparatus of claim 9, wherein the second filter filters the virtual force-feedback signal having a low frequency component in the combined signal.

12. The apparatus of claim 1, wherein the signal output part includes:
a first output part configured to output the virtual vibrotactile signal of which a signal characteristic is adjusted; and
a second output part configured to output the virtual force-feedback signal of which a signal characteristic is adjusted.

13. A method of providing a virtual texture, comprising:
a signal generation operation of generating a virtual vibrotactile signal and a virtual force-feedback signal of a target object;
a signal adjustment operation of adjusting signal characteristics of the virtual vibrotactile signal and the virtual force-feedback signal; and
a signal output operation of outputting the adjusted virtual vibrotactile signal and the adjusted virtual force-feedback signal to provide virtual tactile information to a user.

14. The method of claim 13, wherein the signal generation operation includes:
generating the virtual vibrotactile signal through a simulation of a vibration model of the target object; and
generating the virtual force-feedback signal through a simulation of a geometric model of the target object.

15. The method of claim 14, wherein the vibration model is made by obtaining vibration acceleration data generated when the user comes into contact with a surface of the target object and modeling a changing pattern of the obtained acceleration data by using machine learning of a neural network.

16. The method of claim 14, wherein the geometric model is made by obtaining geometric data of the target object using at least one sensor of an image sensor and a touch sensor and modeling the obtained geometric data.

17. The method of claim 13, wherein the signal adjustment operation includes a first adjustment operation of adjusting a size of the vibrotactile signal to have a predetermined ratio with a size of the virtual force-feedback signal.

18. The method of claim 13, wherein the signal adjustment operation includes a second adjustment operation of adjusting frequency components of the virtual vibrotactile signal and the virtual force-feedback signal.

19. The method of claim 18, wherein the second adjustment operation includes:
performing short-time Fourier transforms on the virtual vibrotactile signal and the virtual force-feedback signal;
combining the transformed virtual vibrotactile signal and the transformed virtual force-feedback signal to generate a combined signal;
filtering the combined signal; and
performing inverse short-time Fourier transforms on the filtered signals.

20. The method of claim 19, wherein the filtering of the combined signal includes:
obtaining the virtual vibrotactile signal having a high frequency component from the combined signal using a high pass filter; and
obtaining the virtual force-feedback signal having a low frequency component from the combined signal using a low pass filter.
